(19) United States
(12) Patent Application Publication
(10) Pub. No.: US 2006/0095320 A1
(43) Pub. Date: May 4, 2006

(54) System and method of electronic advertisement and commerce

(76) Inventor: Lisa S. Jones, Marietta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/980,086

(22) Filed: Nov. 3, 2004

(51) Int. Cl. G06Q 30/00

(52) U.S. Cl. 705/14

(57) ABSTRACT

A system and method of electronic advertisement and commerce, wherein commercial advertisements are electronically mailed to a prospective and/or current consumer via a global networking system. Following completion of the commercial advertisements, an electronic “pop-up” page or window prompts or enables the consumer to access live chat-rooms to discuss or inquire into the advertised products/services; electronically submit his/her telephone number for permitting a sales representative to call the consumer on behalf of the product/service advertiser and thereby respond to the consumer's specific product/service-related inquires; and/or further conduct electronic-business transactions for purposes of ordering products or services depicted in the commercial advertisements, making bill or invoice payments for existing products or services, or the like.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to advertising methods and forums, and more specifically to a system and method of electronic advertisement and commerce. The present invention is particularly advantageous for, although not strictly limited to, targeting advertising efforts toward a specific prospective and/or current consumer market.

### BACKGROUND OF THE INVENTION

Advances in the digital millennium have resulted in significant changes in our methods of communication, commerce and advertisement. For instance, global networking systems (i.e., the Internet) provide an effective advertising forum for many business entities seeking to cast a broad advertising net over a general consumer group or, alternatively, enable such entities to target select consumer groups by creating meta-tags or keywords within the entities' online website or advertisements, whereupon keyword searches conducted by an Internet-user through conventional online search engines trigger or display the associated advertisements.

Additionally, global networking systems have enabled the construction and viability of online retail services or “electronic store fronts” as a relatively inexpensive alternative to physical retail stores. Indeed, such electronic retail services have flourished throughout global networking systems and often serve as the primary resource of goods and services to many consumers.

Accordingly, it comes as no surprise that many business entities and small merchants alike request the assistance of advertising and marketing companies in developing and implementing effective online or electronic advertising packages as a primary advertising vehicle. In response thereto, such advertising and marketing companies have allotted significant resources, including conducting exhaustive market surveys and consumer analyses, in developing advertising packages intended to effectively capture and solicit business from prospective consumers, and maintain business relations with existing consumer groups.

Unfortunately, however, many online advertising efforts do not provide for immediate consumer response and, further, do not provide consumer-specific information. For instance, many “content-limited” online advertising efforts, such as, for example, online FLASH, JAVA-enabled, or SHOCKWAVE commercials or banners, typically request the Internet-user to visit a certain webpage or “click” a related link for more information, whereupon the consumer/Internet-user is forced to expend his/her personal time in navigating through a business entity's webpage and/or related links in an effort to uncover desired product or service information, if even available. Notably, such advertising methods often leave the consumer feeling somewhat neglected or detached from the business entity and, accordingly, many consumers will abandon any interest they may have had in that particular business entity's product—turning instead to a more consumer-friendly and readily-responsive business solicitation.

In all likelihood, many business entities would indeed welcome and entertain a consumer's immediate inquires if such entities were somehow alerted or notified of same following the consumer's viewing of an associated commercial, banner, or other online advertisement. Unfortunately, however, absent the availability of an expeditious and real-time response system that will enable business entities to provide consumers with immediate and consumer-specific or consumer-requested product/service information and feedback following an associated online advertisement, most consumers will likely not expend the time and effort required in further researching the product and/or service and, as such, simply lose interest in same.

Therefore, it is readily apparent that there is a need for a system and method of electronic advertisement and commerce, wherein business entities may provide, via a global networking system, the general consumer market, or a targeted consumer market, with an electronic advertisement, whereupon following completion of the advertisement, consumers are directed to or provided with an immediate telephonic and/or real-time response system in which sales representatives of the associated business entity may provide instant consumer-specific or consumer-requested product/service information and feedback.

### BRIEF SUMMARY OF THE INVENTION

Briefly described, in a preferred embodiment, the present invention overcomes the above-mentioned disadvantages and meets the recognized need for such an invention by providing a system and method of electronic advertisement and commerce, wherein commercial advertisements are electronically mailed to a prospective and/or current consumer via a global networking system. Following completion of the commercial advertisements, an electronic “pop-up” page or window prompts or enables the consumer to access live chat-rooms to discuss or inquire into the advertised products/services; electronically submit his/her telephone number for permitting a sales representative to call the consumer on behalf of the product/service advertiser and thereby respond to the consumer's specific product/service-related inquires; and/or further conduct electronic-business transactions for purposes of ordering products or services depicted in the commercial advertisements, making bill or invoice payments for existing products or services, or the like.

According to its major aspects and broadly stated, the present invention in its preferred form is a system and method of electronic advertisement and commerce, generally comprising a global networking system and associated electronic mailing services, an electronic advertisement or commercial, and an e-commerce response system.

More specifically, the present invention is a system and method of electronic advertisement and commerce, wherein one or more commercial advertisements, including video, audio-video, and/or online commercials, such as FLASH, JAVA-enabled, or SHOCKWAVE commercials, are sent by or on behalf of a business entity to a prospective and/or current consumer, or other targeted party, via electronic mail for visual presentation on the consumer's personal computer. After viewing the commercial advertisements, an electronic “pop-up” page or window is displayed on the consumer's computer monitor, wherein the window prompts or permits the consumer to enter a real-time live chat-room associated with the business entity to discuss the advertised products/services with associated sales representatives and/or other consumers, and/or to electronically submit his/her telephone number for immediate telephonic response or call-return service by an associated sales representative; thereby, enabling the consumer to instantaneously receive specific product/service information and place desired product/service orders. Alternatively, and/or in conjunction with the live chat-room or telephonic response features of the present invention, following completion of the commercial advertisement, the consumer may directly enter into electronic-business transactions, such as through secured socket layer (SSL) processing, for purposes of ordering products or services depicted in the commercial advertisements, making bill or invoice payments for existing products or services, or the like.

Accordingly, a feature and advantage of the present invention is its ability to provide a consumer with an electronically mailed product/service advertisement, whereupon completion of same prompts an immediate telephonic and/or real-time response system in which sales representatives may interact with the consumer on behalf of the product/service advertiser.

Another feature and advantage of the present invention is its ability to provide a consumer with an electronically mailed product/service advertisement in conjunction with a telephonic response system for enabling practically contemporaneous contact between a consumer and sales representative.

Still another feature and advantage of the present invention is its ability to provide an electronically mailed commercial product/service advertisement in conjunction with access or link to a live-chat room for discussion of the advertised product/service.

Yet another feature and advantage of the present invention is its ability to provide an electronic advertisement followed by an option to conduct electronic-business transactions for purposes of ordering products or services depicted in the electronic advertisement, making bill or invoice payments for existing products or services, or the like.

Still yet another feature and advantage of the present invention is its ability to be utilized by any entity, organization and/or industry seeking to advertise any of its products, services, upcoming events and the like to the general consumer market or a targeted consumer market, wherein such entities, organizations and/or industries may include, without limitation, utility companies, sports and entertainment industries, political organizations, religious organizations, medical organizations, automobile manufacturers, automobile dealerships, clothing companies, news and television networks, travel agencies, hotel agencies, airline industries, food and drink industries, home product/service industries, business product/service industries, real estate industries, cellular phone industries, academic institutions, dating services, and the like.

A further feature and advantage of the present invention is its ability to enable any entity to target select consumer groups, or any division of the public, by creating meta-tags or keywords within the entities' online website or advertisements, wherein keyword searches conducted by an Internet-user through conventional online search engines triggers or displays the associated advertisement, public service announcement, news broadcast, or the like. Completion of the advertisement/announcement prompts or permits the Internet-user to enter a live chat-room associated therewith, or request immediate telephonic response or call-return service from representatives thereof, for receiving instantaneous feedback and/or additional information regarding same, as described above.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a flow diagram of a system and method of electronic advertisement and commerce according to a preferred embodiment of the present invention; and,

FIG. 2 is an illustration of a graphical user interface depicting a system and method of electronic advertisement and commerce according to a preferred embodiment of the present invention.

### DETAILED DESCRIPTION OF THE PREFERRED AND ALTERNATIVE EMBODIMENTS

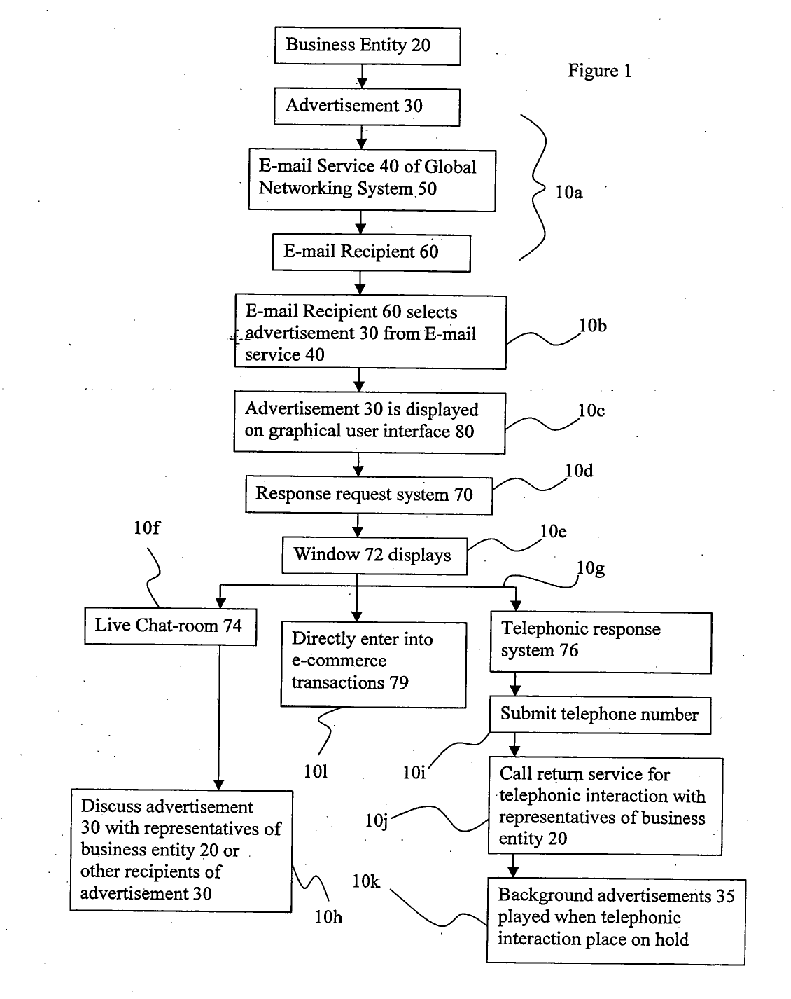

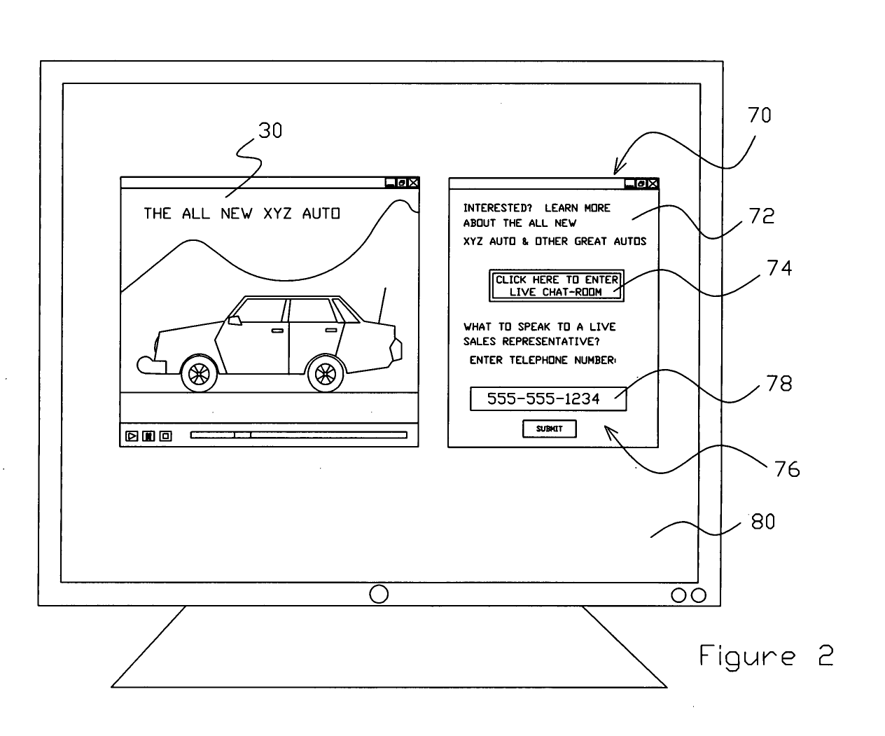

In describing the preferred and alternate embodiments of the present invention, as illustrated in FIGS. 1-2, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-2, the present invention in a preferred embodiment is a system and method 10 of electronic advertisement and commerce, comprising business entity 20, advertisement 30, electronic mailing (e-mail) service 40, global networking system (i.e., Internet) 50, consumer or e-mail recipient 60, and e-commerce response system 70.

Specifically, business entity 20 is preferably any entity, organization and/or industry seeking to advertise any of its current products and/or services, upcoming products and/or services, upcoming events, promotional offerings and the like to the general consumer market or a targeted consumer market. Accordingly such entities, organizations and/or industries may include, without limitation, sports and entertainment industries, automobile manufacturers, automobile dealerships, clothing companies, travel agencies, hotel agencies, airline industries, food and drink industries, home product/service industries, business product/service industries, political organizations, religious organizations, medical organizations, utility companies, real estate industries, cellular phone industries, television networks, academic institutions, dating services, and the like.

Preferably, and as more fully described below, one or more advertisements 30, including, without limitation, video, audio-video and/or FLASH, JAVA-enabled, or SHOCKWAVE commercials, are sent by or on behalf of business entity 20 to consumer/e-mail recipient 60, wherein each advertisement 30 is preferably in electronic or digital format to facilitate dissemination of same through e-mail service 40 of global networking system 50. As such, advertisements 30 may be developed and transmitted in a variety of digital formats, including, without limitation, streaming multi-media files, MPEG-1 files, MPEG-2 files, MPEG-3 files, MPEG-4 files, WAV form audio files, musical instrument digital interface (midi) files, audio video interleaved (avi) files, shortened (shn) files, advanced streaming formats, SDP files, RTSP files, FLC files, SMIL files, QUICKTIME files, WINDOWS MEDIA files, REALTIME files, AIFF files, AMR files, GSM files, 3GPP files, 3GPP2 files, AAC files, 3D files, AMC files, and/or the like. Alternatively, suitable analog-based audio and/or visual advertisements 30 may also be utilized at the discretion of business entity 20.

Consumer/e-mail recipient 60 is preferably one of many prospective consumers within a general consumer market, or, alternatively, one of many prospective and/or current consumers within a targeted consumer group. Indeed, it is contemplated that a plurality of such email recipients 60 may be selected or targeted for receipt of one or more advertisements 30. Preferably, it is contemplated that business entity 20 may obtain the e-mail addresses for a selected consumer group via any suitable and legitimate method, such as, for exemplary purposes only, mailing lists, newsgroups, user groups, public list serves, general public subscription groups, digital bulletin board systems, online voluntary e-mail submittal processes, voluntary e-mail submittal processes at physical retail locations associated with business entity 20, and/or other similar processes.

Referring now more specifically to FIG. 1, with continued reference to FIG. 2, one or more advertisements 30 are preferably sent (Step 10a) by or on behalf of business entity 20 to consumer/e-mail recipient 60 via conventional e-mail service 40 of global networking system 50, whereupon access of e-mail service 40 by e-mail recipient 60 and selection of e-mailed advertisement 30 (Step 10b) preferably results in visual presentation of advertisement 30 on e-mail recipient's 60 personal computer or other suitable graphical user interface 80 (Step 10c).

After viewing advertisement(s) 30, e-commerce response system 70 is preferably triggered or initiated (Step 10d), wherein e-commerce response system 70 preferably functions to provide e-mail recipient 60 with the option of receiving immediate information and/or satisfaction of any inquires he/she may have with regard to the advertised product, service, or the like, depicted in advertisement(s) 30.

More specifically, and as best illustrated in FIG. 2, e-commerce response system 70 preferably includes an electronic “pop-up” page or window 72 displayed (Step 10e) on e-mail recipient's 60 graphical user interface 80, wherein window 72 preferably prompts or permits e-mail recipient 60 to enter real-time live chat-room 74 (Step 10f), utilize telephonic response system 76 (Step 10g), and/or directly enter into electronic-business (e-business or e-commerce) transactions 79 (Step 101), such as through secured socket layer (SSL) processing, for purposes of ordering products or services depicted in advertisement 30, making bill or invoice payments for existing products or services, or the like. It should further be recognized that window 72 may be displayed during transmission of advertisement 30, or immediately thereafter.

Live chat-room 74 is preferably an online discussion forum sponsored by and/or maintained by business entity 20, wherein upon entry into same, e-mail recipient 60 may discuss (Step 10h) the advertised products/services with sales representatives associated with business entity 20. Accordingly, e-mail recipient 60 may request additional product/service information, make transactional requests or place purchase orders (through secured chat-rooms linked to live chat-room 74 and/or other online secured electronic payment processes, including, without limitation, credit card processing, electronic check processing, and electronic bill pay processing), request consumer surveys and/or product/service ratings, request sample products or services on a trial basis, request an in-person conference with local representatives of business entity 20, and the like. Alternatively, e-mail recipient 60 may utilize live chat-room 74 to discuss the advertised product/service with other consumers/e-mail recipients 60 also in receipt of advertisement 30, wherein live chat-room 74 may further provide links to other chat-rooms or on-line discussion forums relating to the product/service depicted in advertisement 30.

Moreover, and with regard to advertisements 30 relating to non-retail subject matter, such as requests for charitable donations or political support, live chat-room 74 may be utilized by e-mail recipient 60 to discuss with representatives of the charitable organization or political party the respective charitable cause, political campaign, or other non-retail subject matter. Alternatively, e-mail recipient 60 may utilize live chat-room 74 to discuss the advertised non-retail subject matter with other consumers/e-mail recipients 60 also in receipt of advertisement 30, wherein live chat-room 74 may further provide links to other chat-rooms or on-line discussion forums relating to the non-retail subject matter depicted in advertisement 30. Additionally, e-mail recipient 60 may pledge donations, contributions, and/or provide information to facilitate entity 20 obtaining such donations or contributions, through live chat-room 74, wherein such donations and/or information may be exchanged through a secured chat-room linked to live chat-room 74, and/or other online secured electronic payment processes, including, without limitation, credit card processing, electronic check processing, and electronic bill pay processing.

In lieu of entering live chat-room 74, or in conjunction therewith, e-mail recipient 60 may elect to utilize telephonic response system 76. Preferably, e-mail recipient 60 electronically submits his/her telephone number through data field 78 of window 72 for immediate telephonic response or call-return service by a sales or other representative of business entity 20 (Step 10i). As such, and preferably within a matter of moments, e-mail recipient 60 will be engaged in a live telephonic interaction with a sales representative (Step 10j) and thus, similar to the advantages of live chat-room 74, instantaneously receive specific product/service information, place purchase orders, request consumer surveys and/or product/service ratings, request sample products or services on a trial basis, request an in-person conference with local representatives of business entity 20, and the like.

Moreover, and still further similar to the advantages of live chat-room 74, with regard to advertisements 30 relating to non-retail subject matter, such as requests for charitable donations or political support, telephonic response system 76 may be utilized by e-mail recipient 60 to discuss with representatives of the charitable organization or political party the respective charitable cause, political campaign, or other non-retail subject matter, and further pledge donations and/or contributions for same.

Preferably, during any telephone conversation initiated through telephonic response system 76, and more specifically while e-mail recipient 60 is placed on hold, awaits connection with a representative of business entity 20, or awaits purchase order processing, background audio advertisements 35 are played (Step 10k); thereby, enabling business entity to still further advertise or promote the products/services (or non-retail subject matter) initially depicted in advertisement 30, and/or promote other offered products and/or services (or non-retail subject matter).

It should be recognized that the telephonic interactions held by and between e-mail recipient 60 and a representative of business entity 20 may be conducted through Internet or web-enabled phone services (i.e., VoIP), conventional landline telephone services, cellular phone services, and the like.

In lieu of utilizing live chat-room 74 or telephonic response system 76, or in conjunction therewith, following completion of advertisement 30, window 72 may further prompt (Step 101) e-mail recipient 60 to directly enter into further e-business or e-commerce transactions 79, such as through secured socket layer (SSL) processing, for purposes of ordering products or services depicted in advertisement 30, making bill or invoice payments for existing products or services, or the like. Similarly, in conducting such e-business or e-commerce transactions 79, e-mail recipient 60 may request additional product/service information, make transactional requests or place purchase orders, request consumer surveys and/or product/service ratings, request sample products or services on a trial basis, request an in-person conference with local representatives of business entity 20, and the like. Moreover, and with regard to advertisements 30 relating to non-retail subject matter, such as requests for charitable donations or political support, e-mail recipient 60 may pledge donations and/or make contributions through e-commerce transactions 79.

It should further be recognized that system and method 10 may be implemented via other suitable online advertising processes. Accordingly, it is contemplated that system and method 10 may implemented by entity 20 initially creating meta-tags or keywords within entity's 20 online website or advertisements. As such, keyword searches conducted by an Internet-user (i.e., the specific audience, consumer group, or division of the public) through conventional online search engines (YAHOO, GOOGLE, or the like) will trigger the associated advertisement, public service announcement, news broadcast, or the like. Whereupon completion of the advertisement/announcement 30 prompts or permits the Internet-user to enter live chat-room 74 associated therewith, or utilize telephonic response system 76 to request immediate telephonic response or call-return service from representatives thereof; thus, receiving instantaneous feedback and/or additional information regarding the advertisement/announcement 30. In such instances where advertisement/announcement 30 is a public service announcement or news broadcast concerning emergency weather reports, national security issues and/or political issues, live chat-room 74 and/or telephonic response system 76 of system and method 10 provide the Internet-user with an effective source of immediate information, feedback and participation.

Additionally, it is contemplated that system and method 10 may be utilized by any entity 20 as a convenient “bill pay reminder service” for its existing consumer base. For example, if entity 20 were a utility or cable company, entity 20 could send e-mail recipient 60 a reminder e-mail through conventional e-mail service 40 of global networking system 50, whereupon access of e-mail service 40 by e-mail recipient 60 and selection of the e-mailed reminder would result in the display of a “remember to pay your bill” advertisement 30. Following completion of the “remember to pay your bill” advertisement 30, e-mail recipient 60 could be prompted to utilize live chat-room 74 and/or telephonic response system 76 to interact with representatives of utility or cable entity 20, discuss the current utility/cable bill or plan, and/or pay the outstanding bill through online bill pay services, secured chat rooms linked to live chat-room 74, or via telephone.

It should be recognized that system and method 10 may be implemented, and advertisements 30 sent, through online instant messaging services, such as, for exemplary purposes only, AOL INSTANT MESSAGING (AIM).

It should further be recognized that system and method 10 may be implemented through any electronic device adapted to connect with global networking system 50, including, without limitation, handheld personal computers, personal data assistants (PDAs), combination PDAs and cellular phone devices, and the like, incorporating wireless Internet technologies, and the like.

Having thus described exemplary embodiments of the present invention, it should be noted by those skilled in the art that the within disclosures are exemplary only, and that various other alternatives, adaptations, and modifications may be made within the scope of the present invention. Additionally, merely listing or numbering the steps of a method in a certain order does not constitute any limitation on the order of the steps of that method. Accordingly, the present invention is not limited to the specific embodiments illustrated herein, but is limited only by the following claims.

What is claimed is:

1. A system of advertisement, comprising:
an electronically-mailed advertisement comprising a selected subject matter;
an e-commerce response system, said e-commerce response system adapted to provide immediate response to and satisfaction of inquiries or transactional requests presented by a recipient of said electronically-mailed advertisement.

2. The system of claim 1, wherein said electronically-mailed advertisement is selected from the group consisting of audio advertisements, audio-video advertisements, online commercials, multimedia advertisements, and combinations thereof.

3. The system of claim 1, wherein said e-commerce response system is accessible during play of said electronically-mailed advertisement, or immediately thereafter.

4. The system of claim 1, wherein said electronically-mailed advertisement is transmitted by an entity to the recipient.

5. The system of claim 4, wherein said e-commerce response system comprises an option for the recipient to access a live online discussion forum or chat-room to discuss said subject matter of said electronically-mailed advertisement with a representative of the entity or with other recipients of said electronically-mailed advertisement.

6. The system of claim 4, wherein said e-commerce response system comprises an option for the recipient to access a live online discussion forum or chat-room to conduct online transactional requests with regard to said subject matter of said electronically-mailed advertisement.

7. The system of claim 4, wherein said e-commerce response system comprises an option for the recipient to request live telephonic interaction with a representative of the entity to discuss said subject matter of said electronically-mailed advertisement.

8. The system of claim 4, wherein said e-commerce response system comprises an option for the recipient to request live telephonic interaction with a representative of the entity to conduct transactional requests with regard to said subject matter of said electronically-mailed advertisement.

9. The system of claim 8, wherein said e-commerce response system further comprises audio advertisements played during intermissions of said live telephonic interaction.

10. The system of claim 4, wherein said e-commerce response system comprises an option for the recipient to directly enter into e-business or e-commerce transactions for purposes of ordering products or services depicted in said electronically-mailed advertisement, making bill or invoice payments for existing products or services, or other transactional requests.

11. A system of advertisement, comprising:
an electronically-mailed advertisement comprising a selected subject matter;
a e-commerce response system, said e-commerce response system comprising an option for a recipient of said electronically-mailed advertisement, said option selected from the group consisting of access to a live online discussion forum to address said subject matter of said electronically-mailed advertisement, request for live telephonic interaction to address said subject matter of said electronically-mailed advertisement, conducting e-commerce transactions, and combinations thereof.

12. The system of claim 11, wherein said electronically-mailed advertisement is selected from the group consisting of audio advertisements, audio-video advertisements, commercials, multimedia advertisements, and combinations thereof.

13. The system of claim 11, wherein said e-commerce response system is accessible during play of said electronically-mailed advertisement, or immediately thereafter.

14. The system of claim 11, wherein said e-commerce response system is displayed as a pop-up window on the recipient's graphical user interface.

15. The system of claim 11, wherein said electronically-mailed advertisement is transmitted by an entity to the recipient.

16. The system of claim 15, wherein said option to access a live online discussion forum enables the recipient to discuss said subject matter of said electronically-mailed advertisement with a representative of the entity or with other recipients of said electronically-mailed advertisement.

17. The system of claim 15, wherein said option to access a live online discussion forum enables the recipient to conduct online transactional requests with regard to said subject matter of said electronically-mailed advertisement.

18. The system of claim 15, wherein said option to request live telephonic interaction enables the recipient to telephonically interact with a representative of the entity to discuss said subject matter of said electronically-mailed advertisement.

19. The system of claim 15, wherein said option to request live telephonic interaction enables the recipient to telephonically interact with a representative of the entity to conduct transactional requests with regard to said subject matter of said electronically-mailed advertisement.

20. The system of claim 19, wherein said e-commerce response system further comprises audio advertisements played during intermissions of said live telephonic interaction.

21. The system of claim 15, wherein said option of conducting e-commerce transactions enables the recipient to order products or services depicted in said electronically-mailed advertisement, make bill or invoice payments for existing products or services, or other transactional requests.

22. A method of advertising, comprising the steps of:
a. disseminating an electronic advertisement via a global networking system, said electronic advertisement comprising a selected subject matter;
b. providing an e-commerce response system in conjunction with said electronic advertisement, said e-commerce response system comprising an option for a recipient of said electronic advertisement, said option selected from the group consisting of accessing a live online discussion forum to address said subject matter of said electronic advertisement, requesting live telephonic interaction to address said subject matter of said electronic advertisement, conducting e-commerce transactions, and combinations thereof.

23. The method of claim 22, wherein said step of disseminating an electronic advertisement further comprises an entity electronically transmitting said electronic advertisement to the recipient.

24. The method of claim 23, wherein said step of accessing a live online discussion forum enables the recipient to discuss said subject matter of said electronic advertisement with a representative of the entity or with other recipients of said electronic advertisement.

25. The method of claim 23, wherein said step of accessing a live online discussion forum enables the recipient to conduct online transactional requests with regard to said subject matter of said electronic advertisement.

26. The method of claim 23, wherein said step of requesting live telephonic interaction enables the recipient to telephonically interact with a representative of the entity to discuss said subject matter of said electronic advertisement.

27. The method of claim 23, wherein said step of requesting live telephonic interaction enables the recipient to telephonically interact with a representative of the entity to conduct transactional requests with regard to said subject matter of said electronic advertisement.

28. The method of claim 23, wherein said step of requesting live telephonic interaction further comprises audio advertisements played during intermissions of said live telephonic interaction.

29. The method of claim 23, wherein said step of conducting e-commerce transactions further comprises the step of ordering products or services depicted in said electronic advertisement, making bill or invoice payments for existing products or services, or other transactional requests.

30. A system of electronic dissemination of information, comprising:
a message comprising selected subject matter, said message disseminated through a global networking system; and,
an e-commerce response system, said e-commerce response system comprising an option for a recipient of said message, said option selected from the group consisting of access to a live online discussion forum to address said subject matter of said message, request for live telephonic interaction to address said subject matter of said message, conducting e-commerce transactions, and combinations thereof.
